(19) United States
(12) Patent Application Publication
(10) Pub. No.: US 2010/0329593 A1
(43) Pub. Date: Dec. 30, 2010

(54) HYDROSTATIC SUPPORT FOR LARGE STRUCTURES AND IN PARTICULAR FOR LARGE TELESCOPES

(76) Inventor: RAFFAELE TOMELLERI, SOMMACAMPAGNA (Verona) (IT)

Correspondence Address: Pearne & Gordon LLP, 1801 East 9th Street, Suite 1200, Cleveland, OH, 44114-3108, US

(21) Appl. No.: 12/821,889

(22) Filed: Jun. 23, 2010

(30) Foreign Application Priority Data
Jun. 25, 2009 (IT) VR2009A000092

(51) Int. Cl. F16C 32/06

(52) U.S. Cl. 384/12

(57) ABSTRACT

Hydrostatic support for large structures, particularly suitable for large telescopes, wherein is present a hydraulic preloading chamber and a restraining shaft to obtain high static, dynamic rigidity and allow the tilt movements without sliding surfaces, and wherein are present solutions suitable for allowing high supply pressures and reduced oil consumption.

The present invention concerns a hydrostatic support for the hydrostatic support of large structures and in particular hydrostatic support structures of machine tools, telescopes and large-size antennas.

A hydrostatic support system consists of an assembly of hydrostatic supports suitably supplied and connected, and its job is to support and constrain, or else just constrain, a structure, in a rigid and stable way, placing an oil film between the hydrostatic supports to and the guide surface, or surfaces, so as to allow their movement with very little effort and in the absence of wear.

Let us first of all define the meaning of the following terms:
runner is a part of the hydrostatic support and is coupled to the guide,
pocket is a recess obtained in the runner, wherein the oil is conveyed under pressure through the supply hole,
seeping surface is the surface of the runner above which the oil passes from the pocket to the oil recovery channel, thereby achieving the separation of the runner from the guide,
hydrostatic meatus is the oil film positioned between the seeping surface and the guide when the hydrostatic runner is supplied,
tilting in the two directions defines a hydrostatic support the runner of which is able to turn in the two directions to adapt to the positioning of the guide,
floating defines a hydrostatic support the runner of which is able to move axially in relation to its base as a result of the stresses coming from the guide, whereby, as a result of such stresses, the hydrostatic support can adopt different heights,
master hydrostatic support defines a hydrostatic support the height of which is fixed or controlled and is not therefore floating,
slave hydrostatic support defines a hydrostatic support which is floating.

When a structure of large dimensions has to be supported or guided hydrostatically, a number of hydrostatic supports must be adopted which can often be much higher than that theoretically needed to exercise the hydrostatic constraint, and this for the purpose of spreading the weight over several hydrostatic supports, and also for the purpose of increasing both the static and dynamic rigidities, thereby making it possible to increase the structures own frequencies.

In a hydrostatic support system, the task of maintaining the position of the structure in a preset or controlled way is entrusted to at least a part of the hydrostatic supports, called position supports or “master” supports, while any remaining hydrostatic supports have the task of bearing a part of its weight or increasing the rigidity, and are called strength hydrostatic supports or “slave” hydrostatic supports.

When fitting hydrostatic supports to large-size structures, the hydrostatic supports must be able to accept the angular geometric errors of the guides caused both by construction errors and by structural deformations, in particular due to non-uniform heat expansions, which in the case of large structures can reach very high values.

This requirement translates into the need for the runner to be tilting, i.e., for it to be able to turn in the two directions, for the purpose of adapting to the positioning of the guide. Hydrostatic supports, especially those fitted to telescopes, are generally required to obtain high levels of static and dynamic rigidity in order to increase the structure's own frequencies.

Hydrostatic supports fitted in particular to telescopes also require the outside temperatures, of the guides and of the hydrostatic supports themselves, to be kept at a temperature with differences within ±1° C. in relation to the temperature of the structure. With the currently adopted solutions, this means limiting the pocket pressure to values not above approx. 40-50 bar, considering that the heating is proportionate to it, managing with these pressure values to keep the oil temperature at about −1° C. inside the pocket and at about +1° C. at the runner exit. It must be taken into account that the temperature of the oil inside the pocket is important because the oil present in the pocket cools a portion of guide which can then be exposed to the air following a sufficiently rapid movement of the axis. The limitation of the pocket pressure to the above-indicated values involves the adoption of hydrostatic supports of reduced load capacity, dimensions being equal, or the adoption of large-size hydrostatic supports, load capacity being equal.

In the case of large telescopes, it is also necessary that these do not produce vibrations, not even minor ones, and consequently no sudden movements must occur during the change of position of the runner, as could happen in the case of stick-slip phenomena, or jerky movements caused by friction sliding in the case of sliding couplings.

The hydrostatic supports must also be able to share out the load in an acceptable way among themselves in case of a power cut, including in emergency conditions and also considering the case of an earthquake.

The hydrostatic supports are also required to dissipate the least possible quantity of energy, i.e., supply pressure being equal and up to a given height of the hydrostatic meatus, the flow of oil to the hydrostatic support must be as much as possible limited.

The hydrostatic supports are also required, inasmuch as possible, to have very limited deformations, so as to allow the use of smaller hydrostatic meatus, reducing the oil flow and increasing its rigidity.

Hydrostatic support systems exist which only partially comply with the above-described requirements.

Hydrostatic support systems exist which use a certain number of “master” hydrostatic supports and a certain number of “slave” hydrostatic supports, but such hydrostatic supports, inside, use ball joints, or universal joints, which do not appear rigid enough unless they are properly preloaded, but such preloading increases the risk of overloading the surfaces, and furthermore the friction present between the surfaces of such ball joints can cause stick-slip phenomena during the change in position of the runner.

The hydrostatic supports currently in use do not employ solutions such as to allow adopting pocket pressures higher than that previously indicated without producing differences in guide and hydrostatic support temperature higher than +1° C. compared to the temperature of the structure.

Hydrostatic supports exist that cater for most of the above-indicated requirements, but the pockets of which, generally rectangular in shape, supply the hydrostatic meatus all along their perimeter, and which do not therefore limit, as would in fact be possible, the flow of oil supplying the hydrostatic support, and this with a big waste of energy.

The main object of the invention is to provide a hydrostatic support that caters for all the above-listed requirements, first of all by obtaining a high static and dynamic rigidity of the master hydrostatic supports.

A further object of the invention is to achieve a high dynamic rigidity of the slave hydrostatic supports.

A further object of the present invention is to enable the runner to perform tilting movements, i.e., to change position, in the two directions without adopting ball joints, universal joints, or other sliding solutions.

A further object of the present invention is to allow adopting high pocket pressures, which do not however produce hydrostatic support and guide temperatures over +1° C. compared to the structure temperature, and this by reducing the dimensions and the cost of the hydrostatic supports.

A further object of the present invention is to obtain a good distribution of the load between the hydrostatic supports including in the presence of big errors in the guidance systems, including in the case of having a large number of hydrostatic supports.

A further object of the present invention is to limit the flow of oil supplying the hydrostatic support, thereby restricting the dissipated energy.

A further object of the present invention is to limit the number of runner deformations.

These objects, and others that will appear from the following description, are achieved, according to the invention, with a hydrostatic support characterised in that:
it has a hydraulic preloading chamber positioned between the base and the runner,
it is tilting without the use of a ball joint or a universal joint because the runner can move at an angle on the oil of the hydraulic chamber,
the oil recycling channel does not surround all the perimeter of the pockets, thereby limiting oil flow and waste of energy,
the hydraulic preloading chamber is supplied through one or more hydraulic damping resistances.
the internal supply to the inner pockets of the runners is by means of channels suitable for ensuring the supply oil only laps a small part of the pocket surface.

The present invention is hereinafter further explained in some preferred practical embodiments, shown by way of example and without any intention of being restrictive, with reference to the attached drawings, wherein:

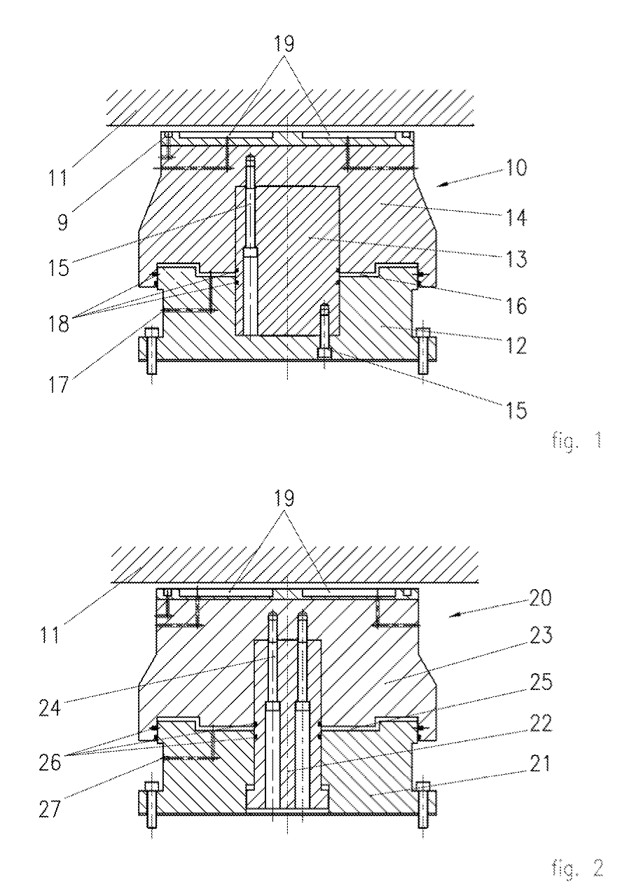

the FIG. 1 schematically shows a section of a master hydrostatic support,

the FIG. 2 schematically shows a section of a slave hydrostatic support,

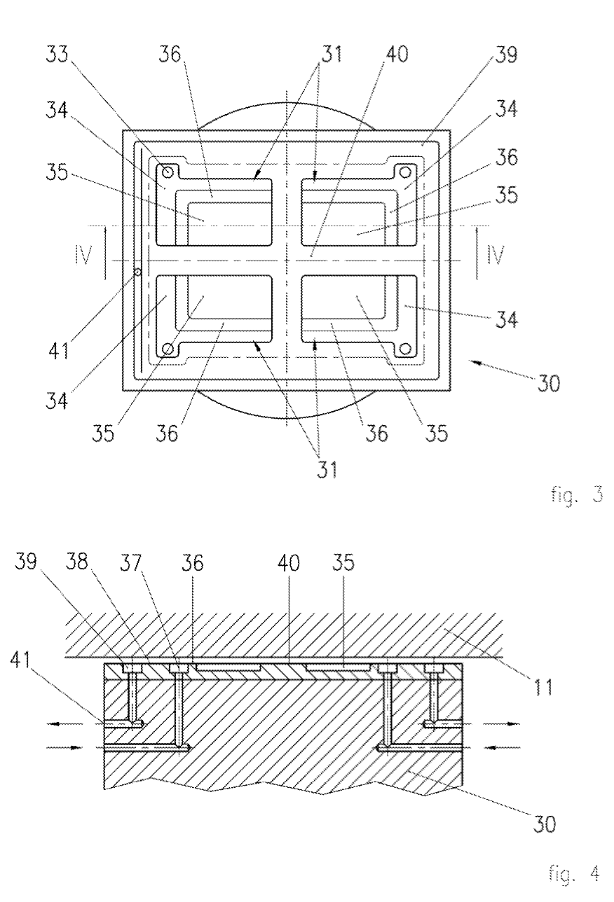

the FIG. 3 schematically shows an arrangement of the pocket channels.

the FIG. 4 schematically shows a section of the runner in a position corresponding to the pocket.

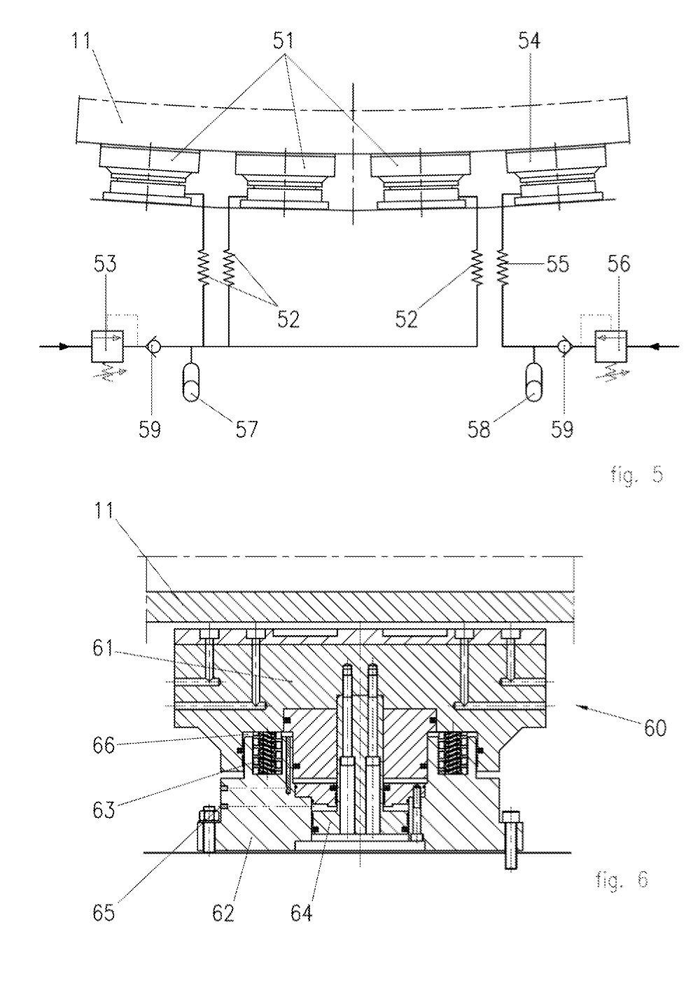

the FIG. 5 schematically shows the hydraulic connection diagram of the hydraulic chambers of three master hydrostatic supports and one slave hydrostatic support,

the FIG. 6 schematically shows a section of the slave hydrostatic support with inner springs and auxiliary cylinder.

The FIG. 1 shows the master hydrostatic support 10 coupled to the guide 11, mainly consisting of the base 12, the constraining shaft 13 and of the runner 14, wherein the screws 15 make the constraining shaft integral both with the base and with the runner. In the runner are obtained the pockets 19 supplied with the oil through the respective supply holes.

The dimensions of the restraining shaft 13 and the lateral plays in the seats, are such as to allow this to bend in both the directions as a result of a different position of the guide in relation to the runner, and consequently the runner is in fact made tilting in the two directions.

The hydraulic preloading chamber 16, the seal of which is by means of the seals 18, is positioned between the base and the runner, and it is supplied at the required pressure through the hole 17 to achieve the preloading of the runner.

The length of the coupling between the runner and the base, in a position corresponding to the outer seal 18, is short enough to allow the runner to tilt by big enough angles but which do not create interferences.

The FIG. 2 shows the slave support 20 coupled to the guide 11, mainly consisting of the base 21, of the constraining shaft 22 and of the runner 23, wherein the screws 24 make the constraining shaft integral with the runner. In the runner are obtained the pockets 19 supplied by the oil through the respective supply holes. The slave hydrostatic support has the property of being floating, i.e., of being able to change its height, inasmuch as the restraining shaft is not fastened to the base, and the hydraulic preloading chamber 25, supplied at the required pressure, determines the force to be discharged on the runner and does not restrain the axial position of the runner, and consequently the hydrostatic support can change its height within the limits allowed by maximum stroke.

The dimensions of the restraining shaft and the plays present 22 are such as to allow this to bend in both directions as a result of a different positioning of the guide in relation to the support, thereby in fact making the runner tilting in the two directions.

The hydraulic preloading chamber 25, the seal of which is provided by the seals 26, is placed between the base and the runner and is supplied through the hole 27 to preload the runner at the required pressure.

The FIG. 3 with its plan view, and the FIG. 4 with a section along the plane of section IV-IV, show the embodiment solution of the pockets and of the supply channels of the invention. The two figures first of all show that the recovery channel 39, which collects the oil coming from the pockets and conveys it towards the recovery hole 41, is only obtained in the outer part of the runner 30 and does not extend inside between one pocket and the other, and consequently the hydrostatic meatus extends from the pockets towards the recovery channel and not between one pocket and another. The illustrations show the four pockets 31 of the runner 30, wherein the oil supply comes from the four holes 33 through which the oil supplies the hydrostatic meatus by means of the four supply channels 34 having an L shape, such as to reach all the perimeter affected by the hydrostatic meatus. Among the four supply channels 34 and the inner pockets 35 are the four reliefs 36 which, though ensuring the supply pressure affects the whole pocket including in the initial condition of contact between the runner and the guide before lifting, are so close to the guide to result in the supply oil flow only lapping a small part of the pocket, which is practically that determined by the extension of the supply channels 34.

It is important for the pocket surface to be large enough to ensure the detachment of the runner from the guide when the supply pressure only reaches the pocket surface. To ensure this, it is important for the reliefs 36 not to come into contact with the guide when the hydrostatic support is not supplied, but to leave a minimum transit so the supply pressure affects the whole pocket.

The FIG. 5 shows three master hydrostatic supports 51, the hydraulic chambers of which are supplied through the hydraulic damping resistances 52 at the pressure setting of the pressure reduction valve 53, while the slave hydrostatic support 54 has the preloading chamber supplied by means of the hydraulic damping resistance 55 supplied by the setting pressure of the pressure reduction valve 56. The accumulators 57 and 58 together with the check valve 59 ensure the pressure is maintained for a certain time in case of no supply.

The FIG. 6 shows a slave hydrostatic support 60 coupled to the guide 11, wherein between the runner 61 and the base 62, the springs 63 are present, distributed in a circular area. The auxiliary hydraulic cylinder 64 supplied through the hole 65, allows applying enough compression force to compress the springs 63 in case of wanting to reduce the height of the hydrostatic support to dismantle it for maintenance.

We shall now provide the comments necessary for the illustrations and for the solutions presented in them.

The master hydrostatic support has been presented in the FIG. 1 in a fixed solution, i.e., in the solution wherein the hydrostatic support has a fixed height in view of the fact that the restraining shaft is fixed both to the base and to the runner. Various solutions can be achieved wherein this is of active type, i.e., wherein its height is controlled. One solution is to obtain a master hydrostatic support with controlled height using a slave hydrostatic support wherein the supply to the hydraulic preloading chamber is not regulated by a pressure, but is achieved by supplying this with precise quantities of oil at inlet or outlet by means of two solenoid valves depending on whether the height of the support is to be increased or reduced. Using suitable hydrostatic support height transducers, closed-cycle control can be achieved of the height of the master hydrostatic support with controlled height.

In the fixed-type master hydrostatic support, i.e., with the restraining shaft also fastened to the base, the hydraulic preloading chamber also has the function of placing the preloading chamber parallel to the restraining shaft, the former being much more rigid than the restraining shaft and conveying to the assembly a much higher dynamic rigidity.

Such very high dynamic rigidity is obtained by the presence of the hydraulic damping resistances. The hydraulic damping resistances 52, shown in FIG. 5, which supply the hydraulic chambers of the master supports, have a high value so as not to allow the flow of the oil in relation to the rapidity of the dynamic stresses determined by the operating systems and of the disturbance forces, and consequently, from a dynamic viewpoint, the preloading chamber acts as if it were closed and contributes considerably to the rigidity of the master hydrostatic support.

Both in the master hydrostatic support and in the slave hydrostatic support, the preloading chamber also has the function of determining a distributed preload of the runner which reduces its deformations, thereby allowing the adoption of meatus of lower height with consequent less energy waste and greater rigidity.

The hydraulic damping resistances that supply the preloading chambers of the slave supports also have a value high enough not to allow the flow of the oil in relation to the rapidity of the dynamic stresses determined by the operating systems and to the disturbance forces, and consequently, from a dynamic viewpoint, the preloading chamber acts as if it were closed and contributes considerably to the rigidity of the slave hydrostatic support. It does however have a value low enough to allow the slow axial movement of the runner so as to permit this to follow the height changes determined by geometric errors and heat expansions. The two conditions can both be satisfied considering that the frequencies of the dynamic stresses of the structures and of the operating systems are around one Hertz or a number of Hertz, while the frequencies of the movements of adaptation to the heat expansions or to the geometric variations during the operating conditions are around one hundred times smaller.

A different solution for making the runner tilting could be that of not using any restraining shaft, but simply allowing the runner to directly rest on the hydraulic preloading chamber providing the side restraint by means of the external guide surface.

The solution of the invention which uses a particular type of pocket supply presented in the FIGS. 3 and 4 has the function of ensuring that the hydraulic fluid that reaches the pocket colder than the temperature of the structure, only affects a small part of the inner pocket. It must be considered that, in order to reduce the jump in temperature compared to the structure, the fluid must arrive at a temperature lower than that of the structure so that afterwards the heating during the drawing along the meatus takes it to a temperature above the temperature of the structures, but within the maximum tolerated jump. For the purpose of allowing the use of higher supply pressures it is necessary to foresee that the oil arrive inside the pocket at lower temperatures than those allowed, but this can be accepted with the solution of the invention which by limiting the extension of the pocket surface lapped by the cold oil, in fact limits the cooling of the pocket and guide surface. The hydraulic fluid runs along the channel and supplies the meatus, but the internal protrusion 36 considerably reduces the extension of the pocket and guide surface lapped by the cold supply oil. Alternatively to the solution in FIG. 4, the presence of the relief 36 can be avoided, making the inner pocket 35 of constant depth and very small, also obtaining in this way that the cold oil lap the guide surface corresponding to the supply channels.

The same two FIGS. 3 and 4 show how the recovery channel is only present in the outer perimeter of the hydrostatic support and does not also extend to a position in between the pockets. If it were extended to a position in between the pockets, it would increase the width of the hydrostatic meatus, thereby also increasing the flow of the oil, and would furthermore reduce the effective surface of the hydrostatic support reducing its load capacity, pressure being equal. With this solution, the width of the hydrostatic meatus is restricted to about half the perimeter of each pocket, and this also achieves a better exploitation of the hydrostatic support surface, which has a larger effective surface.

The solution shown in FIG. 6 uses preloading springs in the slave hydrostatic supports, which position between the base 62 and the runner 61, making it possible to apply the required force even in the absence of supply, which can be chosen equal to a fraction of the force that normally has to be withstood by the hydrostatic support. By supplying the auxiliary hydraulic cylinder 64, the springs can be compressed, thereby reducing the height of the support to allow it to be dismantled. This solution is suitable when there is a high number of slave hydrostatic supports and the aim is to share the load out well. This is made possible by the presented solution considering that the springs also maintain their load in the event of no supply. In this case, the auxiliary cylinder 64 also has the function of preloading the hydraulic preloading chamber 66 for the purpose of increasing its rigidity.

In case of no supply, or in case of an earthquake, the average load cannot drop below that exercised by the springs.

The present invention has been illustrated and described in some of its preferred embodiments, but of course executive variations can in point of fact be made to it, without because of this exiting from the protection scope of the present patent for industrial invention.

1. Hydrostatic support, particularly suitable for being part of the hydrostatic supporting system of a large structure and in particular of a large telescope characterised in that:
it comprises a base and a runner between which is placed a hydraulic preloading chamber,
the runner is tilting in relation to the base without using a ball joint or a universal joint,
the oil recovery channel does not surround all the perimeter of the runner pockets,
the hydraulic preloading chamber is supplied through one or more hydraulic damping resistances.

2. Hydrostatic support according to claim 1 characterised in that the supply to the runner pockets is achieved by means of channels that convey the oil which supplies the hydrostatic meatus and which limit the surface lapped by the supply oil to less than half the pocket surface.

3. Hydrostatic support according to claim 1 characterised in that the hydraulic damping resistance has a high enough value to increase its dynamic rigidity.

4. Hydrostatic support according to claim 1 characterised in that it has a restraining shaft fastened to the runner which allows tilt movements in the two directions.

5. Hydrostatic support according to claim 4 characterised in that the restraining shaft is also fastened to the base, but allows tilt movements of the runner in the two directions just the same.

6. Hydrostatic support according to claim 1, characterised in that it has, inside it, springs placed between the base and the runner suitable for supporting a part of the nominal load.

7. Hydrostatic support according to claim 6 characterised in that it has an auxiliary hydraulic cylinder fitted to the restraining shaft which is suitable for applying a force able to compress the springs.
